(19) United States
(12) Patent Application Publication
(10) Pub. No.: US 2020/0111428 A1
(43) Pub. Date: Apr. 9, 2020

(54) DISPLAY DEVICE AND METHOD OF DRIVING THE SAME

(71) Applicant: Samsung Display Co., Ltd., Yongin-si (KR)

(72) Inventors: Youngsoo SOHN, Yongin-si (KR); Yoongu KIM, Seoul (KR); Kwan-Young OH, Hanam-si (KR)

(21) Appl. No.: 16/407,689

(22) Filed: May 9, 2019

(30) Foreign Application Priority Data
Oct. 8, 2018 (KR) 10-2018-0119610

(51) Int. Cl. G09G 3/34; G09G 3/36

(52) U.S. Cl. CPC G09G 3/3406; G09G 2360/16; G09G 2320/0653; G09G 3/3607

(57) ABSTRACT

A display device includes a display panel comprising a plurality of pixels, a light-source configured to provide a light to the display panel and comprising a plurality of emitting blocks, a dimming level calculator configured to calculate dimming levels of the emitting blocks based on an image signal, and a data corrector configured to calculate correction data of pixel data utilizing the dimming levels of the emitting blocks, the correction data having gradually increasing gray levels when the pixel data are higher in gray level than a preset gray level.

### CROSS-REFERENCE TO RELATED APPLICATION

This application claims priority to and the benefit of Korean Patent Application No. 10-2018-0119610, filed on Oct. 8, 2018, the entire content of which is hereby incorporated herein by reference for all purposes as if fully set forth herein.

### BACKGROUND

### 1. Field

Exemplary embodiments of the inventive concept relate to a display device and a method of driving the display device. More particularly, exemplary embodiments of the inventive concept relate to a display device for improving a display quality and a method of driving the display device.

### 2. Description of the Related Art

In recent years, with the development of new technology, display products that are smaller, lighter, and have better performance are being produced. Related art cathode ray tube (CRT) has been widely used in display devices with many advantages in performance and cost. However, as a display device that is relatively thin, light in weight, and low in power consumption and overcomes the shortcomings of the CRT in terms of miniaturization and/or portability, a flat panel display device, such as a liquid crystal display (LCD) and/or an organic light emitting display, has been utilized.

The LCD includes a liquid crystal display panel for displaying an image using light transmittance of a liquid crystal, and a backlight assembly disposed under the liquid crystal display panel and providing light to the liquid crystal display panel.

The liquid crystal display panel includes: an array substrate having pixel electrodes and thin film transistors electrically connected to the pixel electrodes; a color filter substrate having color filters and a common electrode; and a liquid crystal layer interposed between the array substrate and the color filter substrate.

The liquid crystal layer is changed in arrangement by the electric field formed between the pixel electrodes and the common electrode, thereby changing the transmittance of light passing through the liquid crystal layer.

When the transmittance of the light is maximized, the liquid crystal display panel may display a white image with high luminance. However, when the transmittance of the light is reduced to a minimum, the liquid crystal display panel may display a black image with low brightness.

The backlight assembly includes a plurality of light emitting diodes, and a plurality of light emitting diodes may be driven according to a Pulse Width Modulation (PWM) dimming method.

The PWM dimming method controls the amount of light of the light emitting diodes according to the brightness of an image displayed on the liquid crystal display panel.

### SUMMARY

Aspects of exemplary embodiments of the inventive concept are directed toward a display device for improving a display quality of a high-grayscale image.

Aspects of exemplary embodiments of the inventive concept are directed toward a method of driving the display device.

According to an exemplary embodiment of the inventive concept, there is provided a display device including a display panel including a plurality of pixels, a light-source configured to provide a light to the display panel and comprising a plurality of emitting blocks, a dimming level calculator configured to calculate dimming levels of the emitting blocks based on an image signal, and a data corrector configured to calculate correction data of pixel data using the dimming levels of the emitting blocks, the correction data having gradually increasing gray levels when the pixel data are higher in gray level than a preset gray level.

In an exemplary embodiment, the data corrector includes a pixel dimming level calculator configured to calculate a pixel dimming level of a pixel of the pixels, based on the dimming levels of the emitting blocks, a first correction data calculator configured to calculate first correction data using a gain value preset according to the pixel dimming level and the pixel data of the pixel, and a second correction data calculator configured to calculate second correction data using a dimming compensation ratio preset according to the pixel dimming level when the first correction data are higher in gray level than a threshold gray level.

In an exemplary embodiment, the data corrector may be configured to correct the pixel data to the first correction data when the first correction data are lower in gray level than the threshold gray level.

In an exemplary embodiment, a plurality of dimming compensation ratios including the dimming compensation ratio may be differently preset according to a plurality of pixel dimming levels including the pixel dimming level.

In an exemplary embodiment, the second correction data calculator may calculate an adjustment gain value by applying the dimming compensation ratio to the gain value, and calculate the second correction data by applying the adjustment gain value to the first correction data.

In an exemplary embodiment, the second correction data Output_Data_2 may be defined as the following:

Output_Data_2=Output_Data−th_gray×Gain_adj+th_gray,

wherein, Gain_adj is an adjustment gain value and th_gray is a threshold gray level.

In an exemplary embodiment, the display device may further include an image analyzer configured to divide a frame image signal into a plurality of image blocks and calculate representative grayscale data of each image block of the image blocks, and wherein the dimming level calculator is configured to calculate a dimming level of an emitting block of the emitting blocks using the representative grayscale data of the image block.

In an exemplary embodiment, a number of the image blocks may be equal to or greater than a number of the emitting blocks.

In an exemplary embodiment, the emitting block may include at least one light emitting diode.

In an exemplary embodiment, a pixel of the pixels may include a switching element connected to a data line and a gate line; and a liquid crystal capacitor connected to the switching element.

According to an exemplary embodiment of the inventive concept, there is provided a method of driving the display device which comprises a display panel comprising a plurality of pixels and a light-source configured to provide a light to the display panel and comprising a plurality of emitting blocks. The method may include calculating dimming levels of the emitting blocks based on an image signal, calculating correction data of pixel data using the dimming levels of the emitting blocks, and calculating the correction data having gradually increasing gray levels when the pixel data are higher in gray level than a preset gray level.

In an exemplary embodiment, the method may further include calculating a pixel dimming level of a pixel of the pixels based on the dimming levels of the emitting blocks, calculating first correction data using a gain value preset according to the pixel dimming level and the pixel data of the pixel, and calculating second correction data using a dimming compensation ratio preset according to the pixel dimming level when the first correction data are equal to or higher in gray level than a threshold gray level.

In an exemplary embodiment, the method may further include correcting the pixel data to the first correction data when the first correction data are lower in gray level than the threshold gray level.

In an exemplary embodiment, a plurality of dimming compensation ratios including the dimming compensation ratio may be differently preset according to a plurality of pixel dimming levels including the pixel dimming level.

In an exemplary embodiment, the calculating the second correction data includes calculating an adjustment gain value by applying the dimming compensation ratio to the gain value and calculating the second correction data by applying the adjustment gain value to the first correction data.

In an exemplary embodiment, the second correction data Output_Data_2 may be defined as the following:

Output_Data_2=Output_Data−th_grayx Gain_adj+th_gray,

wherein, Gain_adj is an adjustment gain value and th_gray is a threshold gray level.

In an exemplary embodiment, the method may further include dividing a frame image signal into a plurality of image blocks, and calculating representative grayscale data of each image block of the image blocks, wherein a dimming level of an emitting block of the emitting blocks is calculated by using the representative grayscale data of the image block.

In an exemplary embodiment, a number of the image blocks may be equal to or greater than a number of the emitting blocks.

In an exemplary embodiment, the method may further include generating a PWM signal applied to at least one light emitting diode in the emitting block based on the dimming level of the emitting block.

In an exemplary embodiment, the method may further include converting the first or second correction data to a data voltage and providing the data voltage to the display panel.

According to exemplary embodiments of the present inventive concept, the display device and the method of driving the display device reduce or eliminate the agglomeration phenomenon that agglomerates high gray levels to a maximum gray level in a dark background image by configuring the pixel data that are higher than a preset gray level to have gray levels gradually increasing from the threshold gray level to a maximum gray level, and, thus, the phenomenon that agglomerates high gray levels to a maximum gray level in a dark background image may be reduced or eliminated.

### BRIEF DESCRIPTION OF THE DRAWINGS

The above and other features and advantages of the inventive concept will become more apparent by describing in detail exemplary embodiments thereof with reference to the accompanying drawings, in which:

FIG. 1 is a block diagram illustrating a display device according to an exemplary embodiment;

FIG. 2 is a block diagram illustrating a data corrector according to an exemplary embodiment;

FIG. 3 is a graph illustrating first correction data generated by a first correction data calculator of FIG. 2 according to an exemplary embodiment;

FIG. 4 is a conceptual diagram illustrating a dimming compensation ratio used in a second correction data calculator of FIG. 2 according to an exemplary embodiment;

FIG. 5 is a graph illustrating second correction data generated by a second correction data calculator of FIG. 2 according to an exemplary embodiment;

FIG. 6 is a block diagram illustrating a pixel dimming level calculator according to an exemplary embodiment;

FIG. 7 is a conceptual diagram illustrating a pixel dimming level calculator according to an exemplary embodiment;

FIG. 8 is a block diagram illustrating a first correction data calculator according to an exemplary embodiment;

FIG. 9 is a conceptual diagram illustrating a gain value look-up table of FIG. 8 according to an exemplary embodiment;

FIG. 10 is a flowchart diagram illustrating a method of driving the display device according to an exemplary embodiment; and

FIG. 11 is a graph illustrating correction data of input data according to a comparative exemplary embodiment and an exemplary embodiment.

### DETAILED DESCRIPTION

Hereinafter, the inventive concept will be explained in detail with reference to the accompanying drawings.

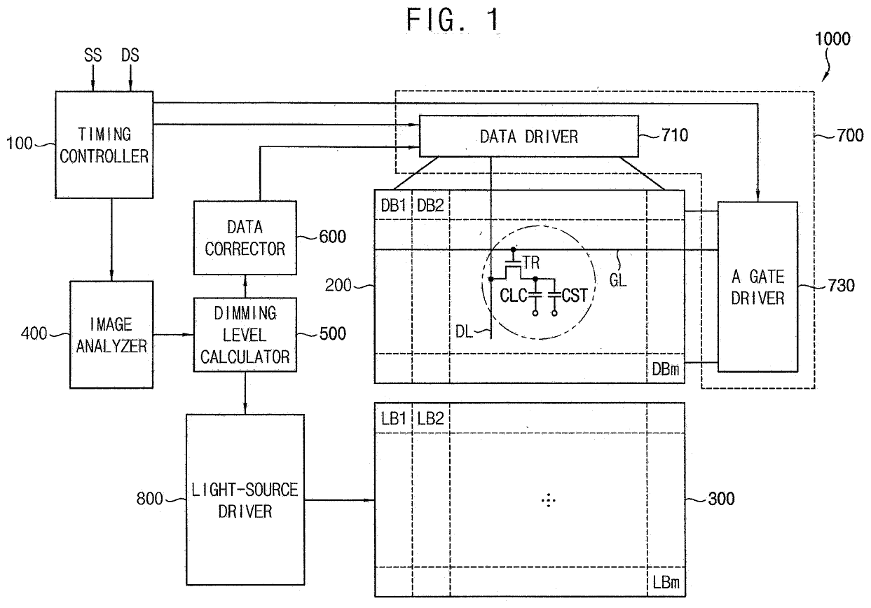

FIG. 1 is a block diagram illustrating a display device according to an exemplary embodiment.

Referring to FIG. 1, the display device 1000 may include a timing controller 100, a display panel 200, a light-source part 300, an image analyzer 400, a dimming level calculator 500, a data corrector 600, a panel driver 700, and a light-source driver 800.

The timing controller 100 receives a synchronous signal SS and an image signal DS from an external device. The timing controller 100 generates a timing control signal for controlling the drive timing of the display panel 200 using the synchronous signal SS. The timing control signal includes a clock signal, a horizontal synchronization signal, and a vertical synchronization signal.

The display panel 200 includes a plurality of pixels for displaying an image. Each pixel P includes a pixel switching element TR connected to a gate line GL and a data line DL, a liquid crystal capacitor CLC connected to the pixel switching element TR, and a storage capacitor CST connected to the liquid crystal capacitor CLC.

The light-source part 300 provides a light to the display panel 200. The light-source part 300 includes a plurality of emitting blocks LB, and each of the emitting blocks LB may include at least one light emitting diode string.

The emitting block LB may generate a light having a luminance based on an image displayed on a corresponding display block DB of the display panel 200.

The emitting block LB may be arranged in a linear structure, or may be arranged in a matrix structure. The light-source part 300 may be driven in a local dimming mode by the plurality of the emitting blocks LB.

The image analyzer 400 divides a frame image into a plurality of image blocks by using the synchronous signal SS and the image signal DS received from the external device and calculates representative grayscale data of an image block using minimum grayscale data, maximum grayscale data, or average grayscale data of the image block.

A number of image blocks may be set to be equal to or greater than that of the emitting blocks. The image analyzer 400 calculates a plurality of representative grayscale data respectively corresponding to the plurality of image blocks.

The number of the image blocks may be equal to the number of the display blocks in the display panel 200 corresponding to the plurality of emitting blocks. Alternatively, the number of the image blocks may be larger than the number of the display blocks.

The dimming level calculator 500 calculates a plurality of dimming levels of the plurality of emitting blocks using the plurality of representative grayscale data of the plurality of image blocks through algorithms/filters, such as a spatial filter, a temporal filter, an input gamma and/or an output gamma.

The data corrector 600 calculates a pixel dimming level corresponding to the amount of light provided to the pixel using a light distribution profile of the emitting blocks LB based on the plurality of dimming levels.

The data corrector 600 calculates first correction data by applying a gain value preset according to the pixel dimming level to the pixel data of the pixel.

The data corrector 600 calculates the second correction data by applying a dimming compensation ratio preset according to the pixel dimming level to the first correction data when the first correction data are equal to or higher in level than a threshold gray level.

Therefore, gray levels of correction data corresponding to the pixel data being higher in level (gray level) than a preset gray level may gradually increase from the threshold gray level to a maximum gray level, and, thus, an agglomeration phenomenon that agglomerates high gray levels to the maximum gray level in a dark background image may be reduced or eliminated.

The panel driver 700 drives the display panel 200 using the synchronous signal SS and the image signal DS provided from the timing controller 100.

For example, the panel driver 700 includes a data driver 710 for generating a data signal to be provided to the data line DL and a gate driver 730 for generating a gate signal for providing the gate line GL, using a vertical synchronization signal and a horizontal synchronization signal.

The pixel correction data of the pixel data generated by the data corrector 600 may be provided to the data driver 710.

The data driver 710 generates a data voltage using the pixel correction data using a gamma voltage, and provides the data voltage to the data line DL.

The light-source driver 800 generates a plurality of driving signals for driving the plurality of emitting blocks using the plurality of dimming levels provided from the dimming level calculator 500 and provides the plurality of driving signals to the plurality of the emitting blocks. A drive signal may be a PWM (Pulse Width Modulation) signal.

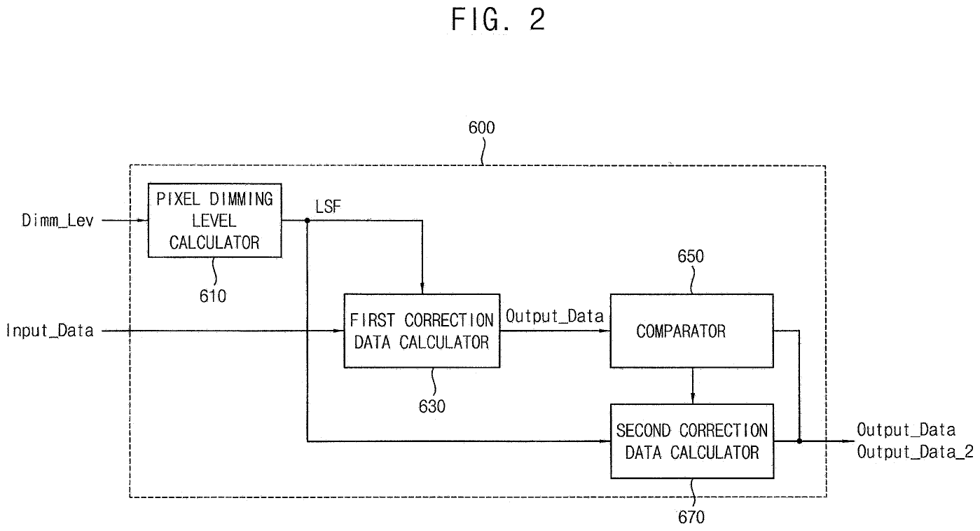

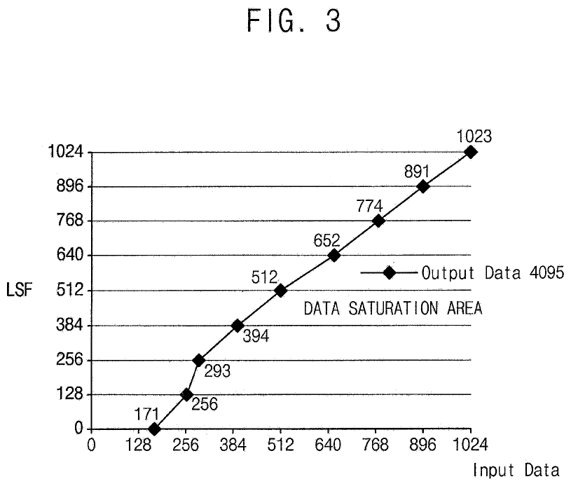

FIG. 2 is a block diagram illustrating a data corrector according to an exemplary embodiment. FIG. 3 is a graph illustrating first correction data generated by a first correction data calculator of FIG. 2 according to an exemplary embodiment.

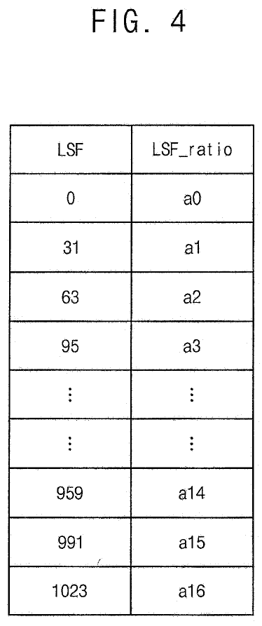

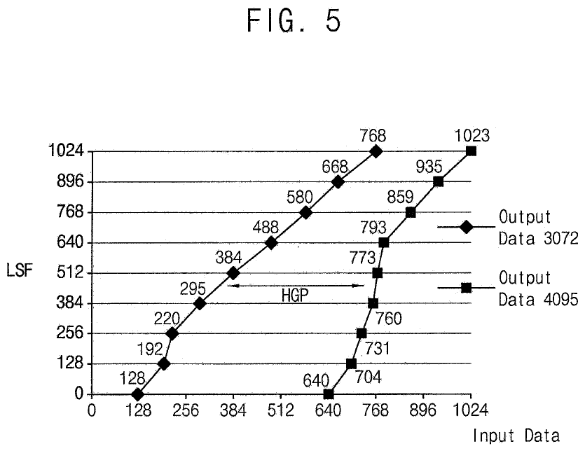

FIG. 4 is a conceptual diagram illustrating a dimming compensation ratio used in a second correction data calculator of FIG. 2 according to an exemplary embodiment. FIG. 5 is a graph illustrating second correction data generated by a second correction data calculator of FIG. 2 according to an exemplary embodiment.

Referring to FIGS. 1 and 2, the data corrector 600 may include a pixel dimming level calculator 610, a first correction data calculator 630, a comparator 650, and a second correction data calculator 670.

The pixel dimming level calculator 610 calculates the pixel dimming level using an optical diffusion function. A pixel dimming level LSF is a dimming level of each pixel by a light generated from a plurality of light emitting blocks driven by the plurality of dimming levels preset according to the optical diffusion function based on the plurality of dimming levels Dimm_Lev of the light-emitting blocks LB.

The first correction data calculator 630 calculates the first correction data by applying a set gain value Gain_org according to the pixel dimming level LSF of the pixel to the pixel data of the pixel.

The pixel data inputted to the first correction data calculator 630 may be 10-bit data, and the first correction data outputted from the first correction data calculator 630 may be 12-bit data.

FIG. 3 is a graph illustrating the maximum grayscale data of 12-bit corrected based on the pixel data Input_Data of 10-bit and the pixel dimming level LSF of 10-bit.

Referring to FIG. 3, when the pixel data Input_Data have a 171-gray level, the pixel dimming level LSF is at a 0-level, the first correction data calculator 630 outputs a maximum gray level that is at a 4095-gray level as the first correction data Output_Data of the pixel data Input_Data that have the 171-gray level.

In addition, when the pixel data Input_Data have a 512-gray level and the pixel dimming level LSF is at a 512-level, the first correction data calculator 630 outputs the maximum gray level that is at the 4095-gray level as the first correction data Output_Data of the pixel data Input_Data that have the 512-gray level.

As shown in FIG. 3, when the pixel data Input_Data have gray levels higher than a preset gray level in the same pixel dimming level LSF, the first correction data calculator 630 constantly outputs the maximum gray level with the 4095-gray level as the first correction data Output_Data of the pixel data Input_Data (Data Saturation Area).

As described above, the pixel data being higher than the preset gray level may be corrected to the first correction data with the same maximum gray level and, thus, an agglomeration phenomenon that agglomerates high gray levels to a maximum gray level in a dark background image may be caused.

In order to reduce or eliminate the agglomeration phenomenon, when the first correction data calculated by the first correction data calculator 630 are equal to or higher than a threshold gray level th_gray, the second correction data Output_Data_2 are calculated by applying the adjustment gain value Gain_adj to the first correction data.

The second correction data Output_Data_2 corresponding to the pixel data from the preset gray level to the maximum gray level may have gray levels gradually increasing from the threshold gray level th_gray to the maximum gray level Max gray.

According to one exemplary embodiment, the comparator 650 compares the first correction data Output_Data calculated from the first correction data calculator 630 with the threshold gray level th_gray. When the first correction data Output_Data are lower than the threshold gray level th_gray, the first correction data Output_Data is output as the correction data of the pixel data.

However, when the first correction data Output_Data are equal to or higher than the threshold gray level th_gray, the first correction data Output_Data are provided to the second correction data calculator 270.

The second correction data calculator 670 calculates second correction data Output_Data_2 by applying the threshold gray level th_gray and the adjustment gain value Gain_adj to the first correction data Output_Data being equal to or higher than the threshold gray level th_gray.

As shown in Equation 1 below, the adjustment gain value Gain_adj is a value obtained by calculating the dimming compensation ratio LSF_ratio in the gain value Gain_org.

Gain_adj=Gain_org×LSF_ratio Equation 1

The dimming compensation ratio LSF_ratio may be differently preset according to a level of the pixel dimming level LSF.

Referring to FIG. 4, the dimming compensation ratio LSF_ratio may be implemented according to a pixel dimming level LSF of 10-bit. For example, 16 dimming compensation ratios LSF_ratio respectively corresponding to 16 pixel dimming levels may be stored as parameters in a memory. Alternatively, the 16 dimming compensation ratios LSF_ratio respectively corresponding to 16 pixel dimming levels may be stored as a look-up table.

The dimming compensation ratios LSF_ratio not stored in the memory may be calculated by a linear interpolation method.

As shown in Equation 2 below, the second correction data calculator 670 calculates the second correction data Output_Data_2 by applying the adjustment gain value Gain_adj to the first correction data Output_Data.

Output_Data_2=Output_Data−th_gray×Gain_adj+th_gray Equation 2

For example, when the first correction data Output_Data have a 4020-gray level, the threshold gray level th_gray is at a 3072-gray level, and the adjustment gain value Gain_adj is ‘768/1024’, the second correction data calculator 670 calculates the second correction data Output_Data_2 to be at a 3783-gray level according to Equation 2.

Therefore, the first correction data Output_Data of the 4020-gray level may be corrected to the second correction data Output_Data_2 of the 3783-gray level.

FIG. 5 is a graph illustrating maximum grayscale data of 10-bit and threshold grayscale data of 10-bit corrected based on the pixel data Input_Data of 10-bit and the pixel dimming level LSF of 10-bit.

Referring to FIG. 5, by the second correction data calculator 670, in a period HGP from the threshold gray level of 3072-gray level to the maximum gray level of 4095-gray level, the first correction data Output_Data may be corrected to the second correction data Output_Data_2 having correction gray levels gradually increasing by applying the adjustment gain value Gain_adj.

Therefore, an agglomeration phenomenon that agglomerates high gray levels to a maximum gray level in the dark background images may be reduced or eliminated.

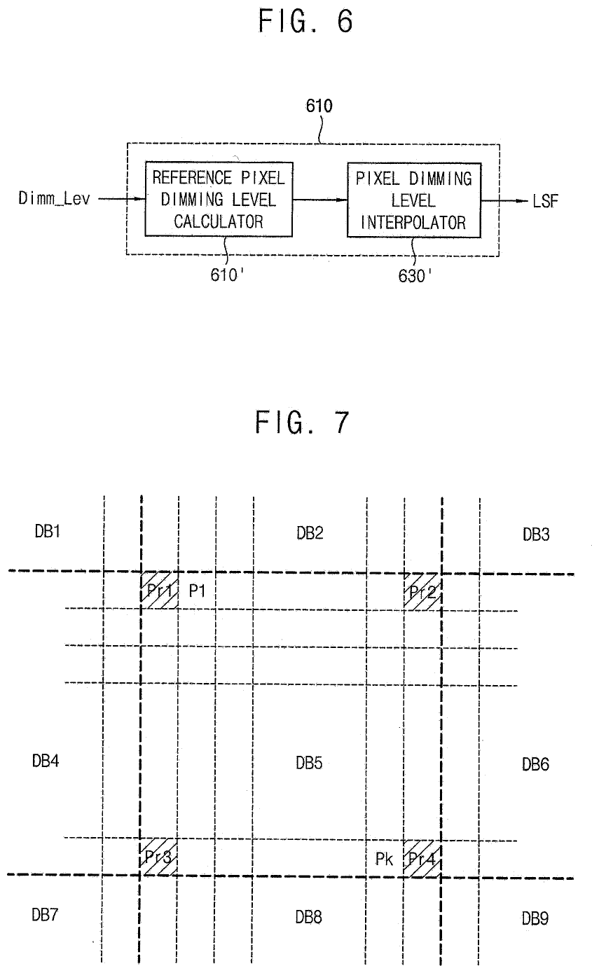

FIG. 6 is a block diagram illustrating a pixel dimming level calculator according to an exemplary embodiment. FIG. 7 is a conceptual diagram illustrating a pixel dimming level calculator according to an exemplary embodiment.

Referring to FIGS. 6 and 7, the pixel dimming level calculator 610 may include a reference pixel dimming level calculator 610′ and a pixel dimming level interpolator 630′.

The reference pixel dimming level calculator 610′ calculates a plurality of reference pixel dimming levels respectively corresponding to a plurality of reference pixels included in the display block using a light diffusion function based on the dimming level of the emitting block.

For example, as shown in FIG. 7, reference pixel dimming levels respectively corresponding to a first reference pixel Pr1, a second reference pixel Pr2, a third reference pixel Pr3, and a fourth reference pixel Pr4 in the fifth display block DB5 may be calculated.

The pixel dimming level interpolator 630′ may calculate pixel dimming levels respectively corresponding to a plurality of pixels P1, . . . , Pk in the fifth display block DB5 using the reference pixel dimming level of the first to fourth reference pixels Pr1, Pr2, Pr3, and Pr4 through a linear interpolation method.

As described above, pixel dimming levels respectively corresponding to all pixels in the display panel may be calculated. The pixel dimming levels may be provided to the first correction data calculator 630 and the second correction data calculator 670.

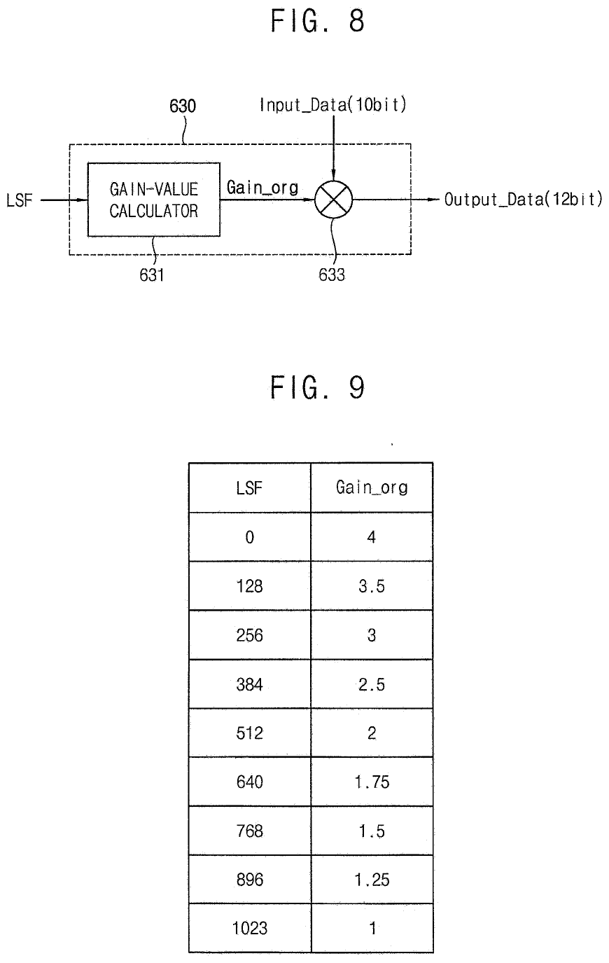

FIG. 8 is a block diagram illustrating a first correction data calculator according to an exemplary embodiment. FIG. 9 is a conceptual diagram illustrating a gain value look-up table of FIG. 8 according to an exemplary embodiment.

Referring to FIGS. 8 and 9, the first correction data calculator 630 may include a gain-value calculator 631 and an operator 633.

The gain-value calculator 631 may include a look-up table LUT in which the gain value Gain_org preset differently according to the pixel dimming level LSF is stored, as shown in FIG. 8.

For example, for pixel dimming levels LSF of 10-bit, the look-up table LUT may store a plurality of gain values Gain_org respectively corresponding to a plurality of sampled pixel dimming levels LSF.

The gain-value calculator 631 may calculate gain values Gain_org corresponding to pixel dimming levels LSF other than the sampled pixel dimming levels LSF stored in the look-up table LUT using a linear interpolation method.

The gain-value calculator 631 calculates the gain value Gain_org corresponding to the pixel dimming level LSF of the pixel corresponding to the pixel data Input_Data using the look-up table LUT.

The operator 633 calculates the gain value Gain_org corresponding to pixel data Input_Data and the first correction data Output_Data corresponding to the pixel data Input_Data and outputs the first correction data Output_Data.

For example, the operator 633 may calculate the first correction data Output_Data of 12-bit corresponding to the pixel data of 10-bit.

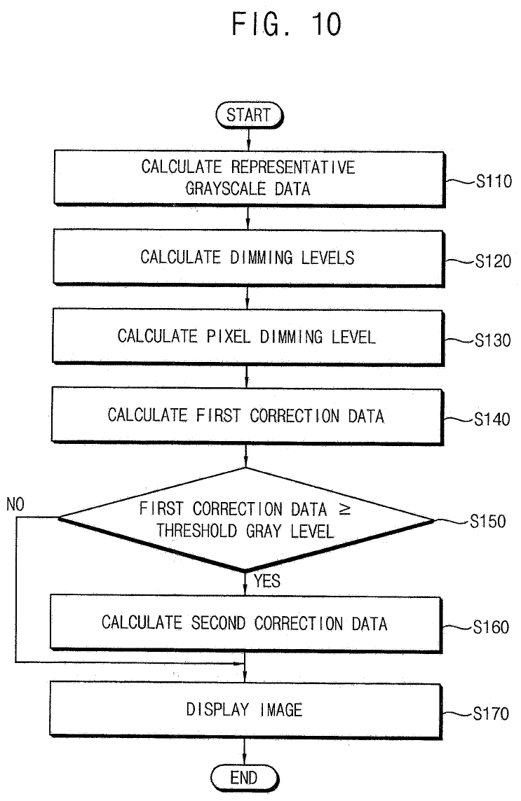

FIG. 10 is a flowchart diagram illustrating a method of driving the display device according to an exemplary embodiment.

Referring to FIGS. 1, 2, and 10, the image analyzer 400 receives a synchronous signal SS and an image signal DS from an external device, divides the frame image into a plurality of image blocks using the synchronous signal SS and the image signal DS, calculates representative grayscale data of each image block using minimum grayscale data, maximum grayscale data, and average grayscale data of each image block (S110).

The dimming level calculator 500 calculates a plurality of dimming levels corresponding to a plurality of emitting blocks using a plurality of representative grayscale data corresponding to a plurality of image blocks through algorithms such as a spatial filter, a temporal filter, an input gamma and/or an output gamma (S120).

The data corrector 600 calculates the pixel dimming level LSF of a pixel using the light diffusion function of the emitting blocks LB based on a plurality of dimming levels (S130).

The data corrector 600 applies the gain value Gain_org preset according to the pixel dimming level LSF to the pixel data Input_Data of the pixel to calculate the first correction data Output_Data (S140).

The data corrector 600 compares the first correction data Output_Data with the threshold gray level th_gray (S150).

When the first correction data Output_Data are equal to or higher than the threshold gray level th_gray, the second correction data Output_Data_2 are calculated by applying the dimming compensation ratio LSF_ratio preset according to the pixel dimming level LSF to the first correction data Output_Data as Equations 1 and 2 (S160).

Therefore, gray levels of correction data corresponding to the pixel data being higher than a preset gray level may gradually increase from the threshold gray level to a maximum gray level, and, thus, an agglomeration phenomenon that agglomerates high gray levels to the maximum gray level may be eliminated.

However, when the first correction data Output_Data are smaller than the threshold gray level th_gray, the first correction data Output_Data are outputted as the correction data of the pixel data.

The panel driver 700 converts the correction data provided from the data corrector 600 into a data voltage using a gamma voltage and outputs the data voltage to a data line of the display panel 200 by a horizontal period.

In addition, the panel driver 700 generates a gate signal synchronized with the output timing of the data voltage and outputs the gate signal to the gate line. Accordingly, in the display panel 200, the transmittance of the liquid crystal is adjusted according to gray levels of the image.

The light-source driver 800 generates a plurality of driving signals (e.g., PWM signals) for driving the plurality of emitting blocks LB using a plurality of dimming levels provided from the dimming level calculator 500.

The light-source driver 800 provides the plurality of driving signals to the plurality of emitting blocks.

Therefore, the light-source part 300 provides the display panel 200 with the light generated in a local dimming driving mode according to the gray levels of an image displayed on the display panel 200.

Accordingly, the display panel 200 displays the image (S170).

According to the exemplary embodiments disclosed herein, using the correction data with gradually increasing gray levels from the threshold gray level to the maximum gray level, an agglomeration phenomenon that agglomerates high gray levels to the maximum gray level may be reduced or eliminated.

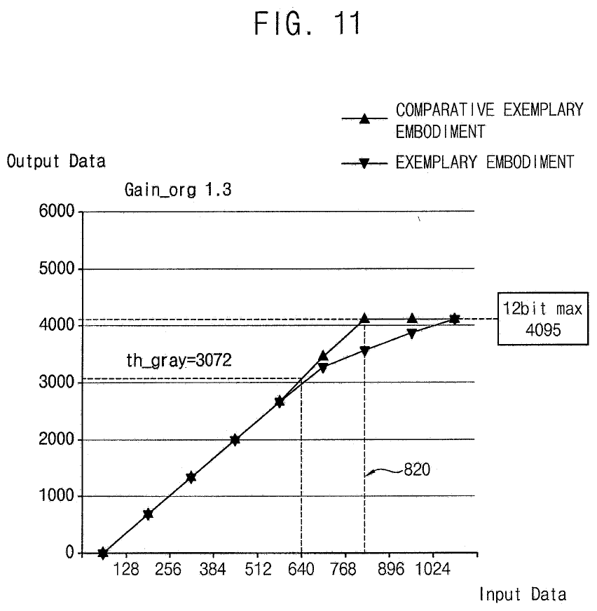

FIG. 11 is a graph illustrating correction data of input data according to a comparative exemplary embodiment and an exemplary embodiment.

Referring to FIGS. 2 and 11, a data corrector of the comparative exemplary embodiment includes only a pixel dimming level calculator 610 and a first correction data calculator 630.

According to the comparative exemplary embodiment, the data corrector calculates the correction data Output_Data of 12-bit corresponding to the pixel data Input_Data of 10-bit.

When the pixel data Input_Data have a gray level more than a high gray level that is at an 820-gray level, the data corrector calculates the correction data Output_Data of 12-bit having a maximum gray level that is at a 4095-gray level among gray levels of 12-bit.

Therefore, in the display device according to the comparative exemplary embodiment, in the dark background image, an inflection point where the maximum gray level of the gamma curve is maintained based on the high gray level is generated, and, thus, an agglomeration phenomenon that agglomerates high gray levels to the maximum gray level in a dark background image may occur.

However, according to the exemplary embodiment, the data corrector calculates the correction data Output_Data of 12-bit corresponding to the pixel data Input_Data of 10-bit.

When the pixel data Input_Data have gray levels being more than a high gray level of a 640-gray level, the data corrector calculates the correction data Output_Data of 12-bit having gray levels gradually increasing from a 3072-gray level of the threshold gray level to a 4095-gray level of the maximum gray level.

According to the exemplary embodiment, gray levels of correction data corresponding to the pixel data being higher than a preset gray level may gradually increase from the threshold gray level to a maximum gray level, and, thus, an agglomeration phenomenon that agglomerates high gray levels to the maximum gray level may be reduced or eliminated.

According to exemplary embodiments of the present invention, in order to improve the agglomeration phenomenon, the pixel data being higher than a preset gray level have gray levels gradually increasing from the threshold gray level to a maximum gray level, and, thus, the agglomeration phenomenon may be reduced or eliminated.

The present inventive concept may be applied to a display device and an electronic device having the display device. For example, the present inventive concept may be applied to a computer monitor, a laptop, a digital camera, a cellular phone, a smartphone, a smart pad, a television, a personal digital assistant (PDA), a portable multimedia player (PMP), an MP3 player, a navigation system, a game console, a video phone, etc.

The use of “may” when describing embodiments of the present invention refers to “one or more embodiments of the present invention.” Also, the term “exemplary” is intended to refer to an example or illustration. As used herein, the terms “use,” “using,” and “used” may be considered synonymous with the terms “utilize,” “utilizing,” and “utilized,” respectively.

The display device and/or any other relevant devices or components according to embodiments of the present invention described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the exemplary embodiments of the present invention.

The foregoing is illustrative of the inventive concept and is not to be construed as limiting thereof. Although a few exemplary embodiments of the inventive concept have been described, those skilled in the art will readily appreciate that many modifications are possible in the exemplary embodiments without materially departing from the novel teachings and advantages of the inventive concept. Accordingly, all such modifications are intended to be included within the scope of the inventive concept as defined in the claims. In the claims, means-plus-function clauses are intended to cover the structures described herein as performing the recited function and not only structural equivalents but also equivalent structures. Therefore, it is to be understood that the foregoing is illustrative of the inventive concept and is not to be construed as limited to the specific exemplary embodiments disclosed, and that modifications to the disclosed exemplary embodiments, as well as other exemplary embodiments, are intended to be included within the scope of the appended claims and equivalents thereof. The inventive concept is defined by the following claims, with equivalents of the claims to be included therein.

What is claimed is:

1. A display device comprising:
a display panel comprising a plurality of pixels;
a light-source configured to provide a light to the display panel and comprising a plurality of emitting blocks;
a dimming level calculator configured to calculate dimming levels of the emitting blocks based on an image signal; and
a data corrector configured to calculate correction data of pixel data utilizing the dimming levels of the emitting blocks, the correction data having gradually increasing gray levels when the pixel data are higher in gray level than a preset gray level.

2. The display device of claim 1, wherein the data corrector comprises:
a pixel dimming level calculator configured to calculate a pixel dimming level of a pixel of the pixels, based on the dimming levels of the emitting blocks;
a first correction data calculator configured to calculate first correction data utilizing a gain value preset according to the pixel dimming level and the pixel data of the pixel; and
a second correction data calculator configured to calculate second correction data utilizing a dimming compensation ratio preset according to the pixel dimming level when the first correction data are equal to or higher in gray level than a threshold gray level.

3. The display device of claim 2, wherein the data corrector is configured to correct the pixel data to the first correction data when the first correction data are lower in gray level than the threshold gray level.

4. The display device of claim 2, wherein a plurality of dimming compensation ratios comprising the dimming compensation ratio are differently preset according to a plurality of pixel dimming levels comprising the pixel dimming level.

5. The display device of claim 2, wherein the second correction data calculator is configured to calculate an adjustment gain value by applying the dimming compensation ratio to the gain value, and calculate the second correction data by applying the adjustment gain value to the first correction data.

6. The display device of claim 5, wherein the second correction data Output_Data_2 satisfies the following:
Output_Data_2=Output_Data−th_gray×Gain_adj+th_gray,
wherein, Gain_adj is the adjustment gain value and th_gray is the threshold gray level.

7. The display device of claim 1, further comprising:
an image analyzer configured to divide a frame image signal into a plurality of image blocks and calculate representative grayscale data of each image block of the image blocks, and
wherein the dimming level calculator is configured to calculate a dimming level of an emitting block of the emitting blocks utilizing the representative grayscale data of the image block.

8. The display device of claim 7, wherein a number of the image blocks is equal to or greater than a number of the emitting blocks.

9. The display device of claim 7, wherein the emitting block comprises at least one light emitting diode.

10. The display device of claim 1, wherein a pixel of the pixels comprises: a switching element connected to a data line and a gate line; and a liquid crystal capacitor connected to the switching element.

11. A method of driving a display device which comprises a display panel comprising a plurality of pixels and a light-source configured to provide a light to the display panel and comprising a plurality of emitting blocks, the method comprising:
calculating dimming levels of the emitting blocks based on an image signal;
calculating correction data of pixel data utilizing the dimming levels of the emitting blocks; and
calculating the correction data having gradually increasing gray levels when the pixel data are higher in gray level than a preset gray level.

12. The method of claim 11, further comprising:
calculating a pixel dimming level of a pixel of the pixels based on the dimming levels of the emitting blocks;
calculating first correction data utilizing a gain value preset according to the pixel dimming level and the pixel data of the pixel; and
calculating second correction data utilizing a dimming compensation ratio preset according to the pixel dimming level when the first correction data are equal to or higher in gray level than a threshold gray level.

13. The method of claim 12, further comprising:
correcting the pixel data to the first correction data when the first correction data are lower in gray level than the threshold gray level.

14. The method of claim 12, wherein a plurality of dimming compensation ratios comprising the dimming compensation ratio are differently preset according to a plurality of pixel dimming levels comprising the pixel dimming level.

15. The method of claim 12, wherein the calculating the second correction data comprises:
calculating an adjustment gain value by applying the dimming compensation ratio to the gain value; and
calculating the second correction data by applying the adjustment gain value to the first correction data.

16. The method of claim 15, wherein the second correction data Output_Data_2 satisfies the following:
Output_Data_2=Output_Data−th_gray×Gain_adj+th_gray,
wherein, Gain_adj is the adjustment gain value and th_gray is the threshold gray level.

17. The method of claim 11, further comprising:
dividing a frame image signal into a plurality of image blocks; and
calculating representative grayscale data of each image block of the image blocks,
wherein a dimming level of an emitting block of the emitting blocks is calculated by utilizing the representative grayscale data of the image block.

18. The method of claim 17, wherein a number of the image blocks is equal to or greater than a number of the emitting blocks.

19. The method of claim 17, further comprising:
generating a PWM signal applied to at least one light emitting diode in the emitting block based on the dimming level of the emitting block.

20. The method of claim 12, further comprising:
converting the first or second correction data to a data voltage; and
providing the data voltage to the display panel.
